(19) United States
(12) Patent Application Publication
(10) Pub. No.: US 2026/0025645 A1
(43) Pub. Date: Jan. 22, 2026

(54) VEHICLE TRACKING SYSTEM USING SMART-PHONE AS ACTIVE TRANSPONDER

(71) Applicant: Amtech Systems, LLC, Albuquerque, NM (US)

(72) Inventors: Kelly Gravelle, Poway, CA (US); John Todd Elson, Albuquerque, NM (US); Greg Lantz, Albuquerque, NM (US); Michael Melville, Albuquerque, NM (US); Paul Hamel, Albuquerque, NM (US)

(73) Assignee: Amtech Systems, LLC, Albuquerque, NM (US)

(21) Appl. No.: 19/340,451

(22) Filed: Sep. 25, 2025

Related U.S. Application Data
(63) Continuation of application No. 18/742,545, filed on Jun. 13, 2024, now Pat. No. 12,483,870.
Application No. 18/742,545 is a division of application No. 17/345,274, filed on Jun. 11, 2021, now Pat. No. 12,015,969.
Application No. 17/345,274 is a division of application No. 15/058,951, filed on Mar. 2, 2016, now Pat. No. 11,039,284.
(60) Provisional application No. 62/127,649, filed on Mar. 3, 2015.
(60) Provisional application No. 62/156,090, filed on May 1, 2015.
(60) Provisional application No. 62/184,162, filed on Jun. 24, 2015.
(60) Provisional application No. 62/214,638, filed on Sep. 4, 2015.
(60) Provisional application No. 62/266,422, filed on Dec. 11, 2015.

(51) Int. Cl. H04W 4/40; H04B 7/10; H04W 4/021; H04W 4/80; H04W 52/02

(52) U.S. Cl. CPC H04W 4/40; H04B 7/10; H04W 4/021; H04W 4/80; H04W 52/0241

(57) ABSTRACT

A system for tracking vehicle position using a smartphone in the vehicle as an active transponder, which is detected by roadside equipment, is described. The system may use existing RF transceivers on the smartphone, such as BLE or WiFi, to periodically transmit an identifying message. Road-based equipment detects and locates the smartphone. The smartphone may be alerted and/or awaken by roadside beacons, and then respond with its identification information. Processing can be performed on the smartphone and/or by roadside or central office equipment. Vehicle location detection can be enhanced through the use of directional antenna matrices, such as a Butler matrix. The system can be used for automated roadway tolling and monitoring.

### CROSS REFERENCE TO RELATED APPLICATIONS

This application is a continuation of U.S. patent application Ser. No. 18/742,545, filed Jun. 13, 2024, which is a divisional of U.S. patent application Ser. No. 17/345,274, filed Jun. 11, 2021, which is a divisional of U.S. patent application Ser. No. 15/058,951, filed Mar. 2, 2016, which claims priority under 35 U.S.C. 119(e) from U.S. Provisional Patent Application No. 62/266,422 filed Dec. 11, 2015; U.S. Provisional Patent Application No. 62/214,638 filed Sep. 4, 2015; U.S. Provisional Patent Application No. 62/184,162 filed Jun. 24, 2015; U.S. Provisional Patent Application No. 62/156,090 filed May 1, 2015; U.S. Provisional Patent Application No. 62/127,649 filed Mar. 3, 2015; and all bearing the same title as the present application. The entire disclosures of each of the applications listed above, including any drawings and appendices, are hereby incorporated herein by reference in their entirety.

### FIELD OF THE INVENTION

The invention relates generally to the field of vehicle tracking and tolling.

### BACKGROUND

The field of electronic vehicle tracking for tolling and other purposes has seen many iterations over the years. These include the use of vehicle-based backscatter transponders detected and communicated with by roadside equipment, active transponders detected and communicated with by roadside equipment, hybrid transponders having both active and backscatter functions; video monitoring of vehicle license plate and other placards. Cellular telephones have also been described for use in tolling systems, alone or in combination with the aforementioned types of transponders, including in application Ser. No. 13/398,337 by one or more of the present inventors.

One problem in tolling applications that exists regardless of the technology used is determination of the roadway lane in which the vehicle is travelling. This is critical for several reasons. Firstly, because open road tolling systems frequently employ multiple transponder detection antennas and systems to cover multiple lanes of travel, it is necessary to accurately determine lane of travel so that vehicles are not recorded more than once per crossing. Secondly, various tolling and roadway traffic management operations provide incentives and/or restrictions for vehicles of different types and occupancy levels, these include the ability to travel in restricted lanes, thus it is necessary to determine if a vehicle is travelling in the required or allowed lane.

The present invention is directed to novel approaches to vehicle tracking and tolling using smartphones as active transponders. A smartphone is defined here as a cellular phone that also has capability to load and run application programs (apps) and that has wireless transceivers beyond the radio used to send voice and data to a cellular network.

### DESCRIPTION OF THE DRAWINGS

FIG. 1 is a diagram of an exemplary embodiment of the inventive system.

FIG. 2 is a diagram of an exemplary embodiment of the inventive system.

FIG. 3 is a diagram of an exemplary embodiment of the inventive system.

FIG. 4 is a diagram of an exemplary embodiment of the smartphone of the inventive system.

FIG. 5 is a diagram of an exemplary Prior Art 8×8 Butler Matrix antenna array.

FIG. 6 is test results of a test-setup using two Butler Matrix antenna arrays.

FIG. 7 is a diagram of an exemplary three-lane system bounded by a Geo-fence.

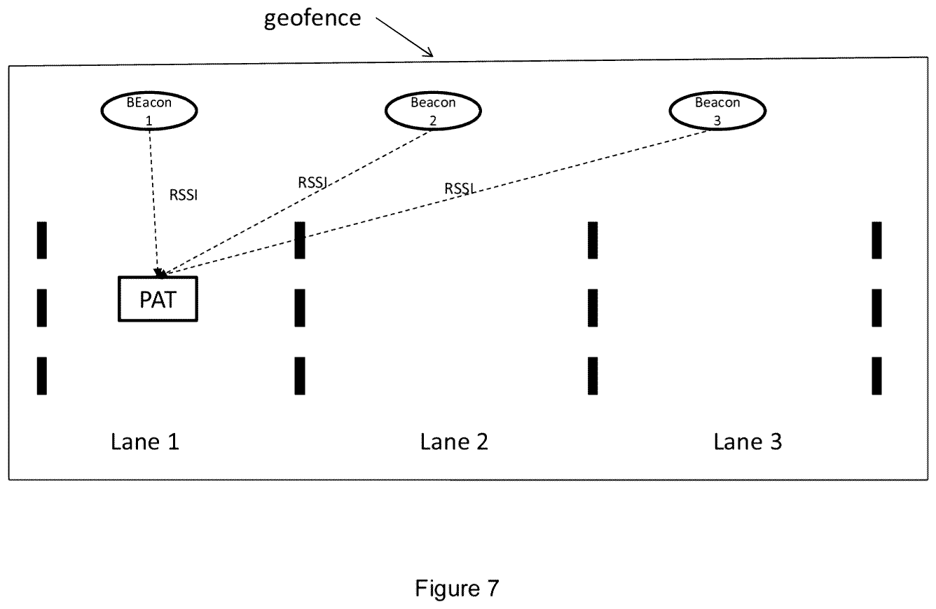

FIG. 8 is a graph of RSSI versus time for beacons in two locations.

### DETAILED DESCRIPTION

Most generally, the system consists of vehicle-based smartphones 1 interacting with external fixed transceivers mounted over the roadway or beside it. The phones 1 and external transceivers 8, 9, 21, 25 are capable of two-way communications, and both transmit and receive functions can be utilized in the system.

The system concept of operations may take several forms:
The phone may transmit to the fixed transceiver
The phone may receive from the fixed transceiver
There may be two-way communication between the fixed transceiver and phone
The wireless protocol may be Bluetooth® Low Energy (BLE), IEEE 802.11/WiFi, or an emergent protocol
A fixed transceiver may utilize a multi-beam antenna
A fixed transceiver may utilize one or more antennas, each providing a single beam covering a single lane or geographic area
Determination of the vehicle's lane of travel or area may be computed by:
   A controller in communication with the fixed transceivers, or
   The mobile unit. In this case, the mobile can transmit its lane number or area to a back office via cellular network, WiFi, BLE, RFID, or any other wireless protocol in use in the phone.

### Communication Protocols

Standard radio protocols such as WiFi and BLE may be used for the transaction, and in principal any protocol with relevant hardware in the phone 1 may be used subject to practical restrictions inherent in the protocol, hardware, and phone software. WiFi probe requests and BLE advertisements are examples of signal formats that can function as beacons in this system. The system can rely on this message alone for lane determination, or additionally utilize responses to the beacon.

To communicate with the smartphone app, fixed transceivers that utilize WiFi and/or BLE protocols are installed in the lane and connected to appropriate antennas. Messages from the phone contain a unique identifier or ID; these messages can be evaluated for received signal strength indication (RSSI). Lane position or proximate antenna position can be determined at a roadside server 20 connected to the transceivers 21 by a communication connection 22, such as Ethernet and TCP/IP or other convenient protocol. When a phone message is received at more than one transceiver 21 (via antennas 6) across the roadway, the unique identifier, along with the RSSI, are sent to the server 20.

Alternately, the lane determination may be made by the phone application resident and running on the phone, based on messages sent from the fixed transceivers to the phone.

### Phone as Transmitter

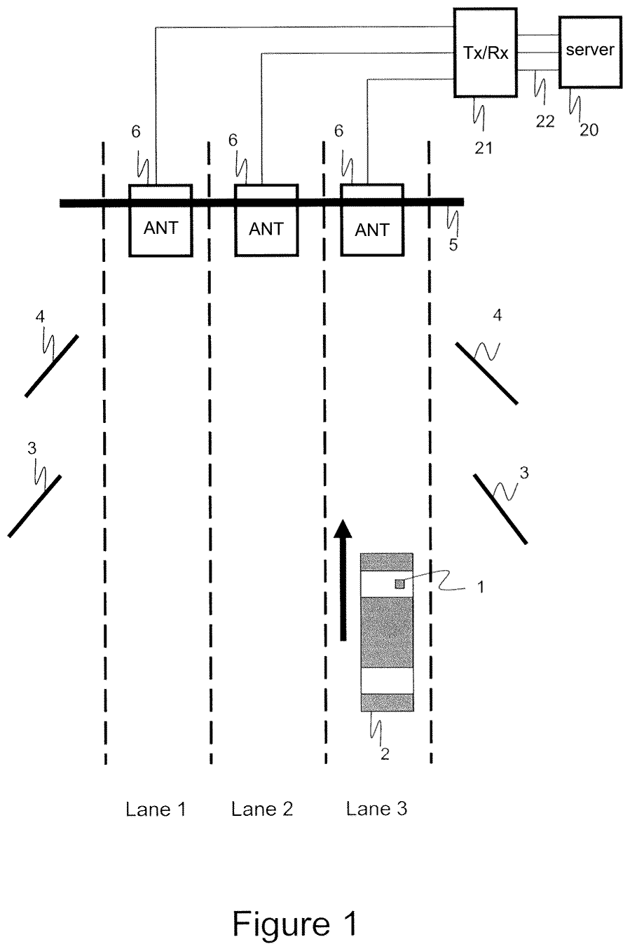

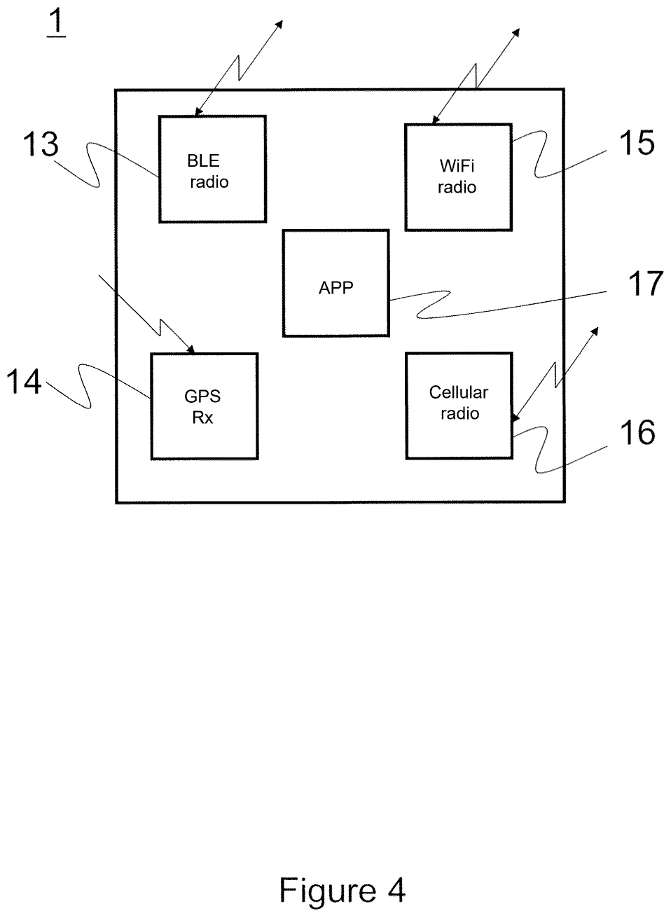

In an embodiment, the invention involves configuring a smartphone 1 as an active transponder for vehicle tracking and/or roadway tolling. The smartphone 1 is adapted to transmit a message periodically that contains a known address or identifier. An exemplary system is described with reference to FIGS. 1-4, with like numbers representing the indicated elements. An existing radio supported on the smartphone 1 such as the WiFi radio 15 or the BLE radio 13 is used to generate these signals. Roadside and/or overhead transceivers (e.g., 8, 9, 21) detect the transmissions to identify the location of the vehicle 2. The phone 1 must be uniquely associated with data content in the message which is associated with an account used to collect the payment of tolls.

In order to perform this task effectively it is necessary that the phone send messages frequently while within the toll zone. A minimum repetition rate of 10 Hz, or one per 100 milliseconds, is required, but 100 Hz or one per 10 milliseconds is preferred. Depending upon power consumption in this high rep rate mode, it may be necessary to overlay GeoZone functionality, such that the higher rep rate/power consumption mode operates only in the vicinity of toll collection zones, thus creating a low duty cycle operation to preserve cell phone battery capacity. GeoZone functionality can be implemented by comparing current GPS position (established by phone's internal GPS receiver/processor 14) to stored geo-location zones selected to include toll point locations. A limitation on this approach is the maximum number of GeoZones in an iPhone is 20. Alternate methods include using BLE beacons 9 to indicate to the phone application 17 that it is in the vicinity of a toll collection point, or by using WiFi AP's 8 SSID's or MAC addresses that are detected by the phone using the phone's WiFi radio 15.

### Signal Strength of Smartphone Signal for Lane Determination

The basic concept of identifying the travel lane relies on RSSI, provided by common WiFi and BLE transceivers used in mobile phones and fixed transceivers. RSSI-based algorithms for range and direction determination must be used with care owing to:
Multipath corruption, occurring when the radio wave from a transmitter bounces off obstacles in its path and arrives at the target with relatively small time offsets from the direct path,
Antenna patterns with nulls in particular directions, and
Sensitivity to polarization.

In any system architecture, it is clear that there are several feasible methods of data processing to determine the lane of travel. The implemented solution also depends on antenna type and location, and also on the disposition of the phone as a transmitter or receiver. In one approach with a phone 1 transmitting and one antenna 6 per lane, the roadside server 20 looks only at messages that meet a minimum threshold of signal strength received from the smartphone 1, then compares the signal strengths received from each antenna to determine the strongest one over a specified period on the order of 30 ms. As the smartphone 1 traverses the roadway each period has a count assigned based on the strongest signal strength received on an antenna. The most proximate antenna 6 or alternatively the lane of travel is determined to be the antenna 6 or lane with the most counts in a larger second period (roughly 300 ms) or the total such counts during a the entire period required to traverse the section of roadway.

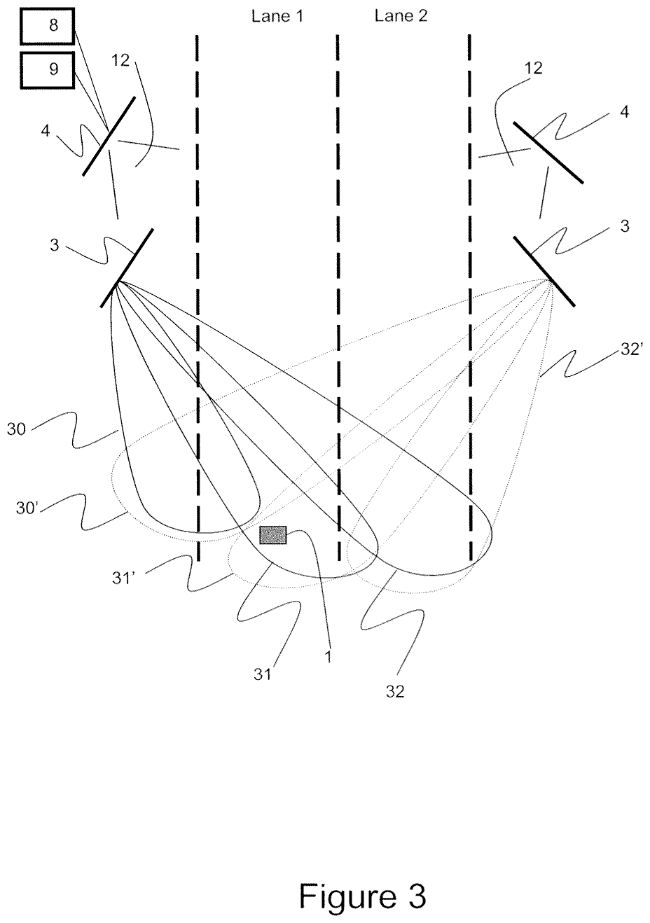

FIG. 3 shows an exemplary design using multi-beam antennas 3 fed by Butler matrices, creating highly directional beam patterns 30, 30′, 31, 31′, 32 and 32′. By determining the strongest signal path between each antenna and the phone 1, either received from the smartphone 1, it is possible to very accurately determine position of the phone and presumable the vehicle. In the example shown, the smartphone 1 is positioned for best reception in beams 31 and 30′, and it is a simple matter from there to determine that these beams intersect in Lane 1.

### Phone as Receiver

In one variation of the system, multiple BLE transmitters, or “beacons” 9, can be installed across the roadway on a gantry 5 and connected to high gain antennas 6. A high gain antenna for purposes of this specification is an antenna with a gain of 8 dB or higher.

In an embodiment, the beacon ID and timestamp are included in its transmitted data to allow the mobile to identify its location at a timestamp. The beacon transmits at a high rate, approximately once per 20 milliseconds. The beacon timestamp is synchronized to local system time to resolve transactions. Specialized beacons with high gain can be used for tracking or localization.

An exemplary beacon is the iBeacon, which uses a protocol developed by Apple®. Various vendors have since made iBeacon-compatible hardware transmitters that advertise their ID to nearby portable electronic devices. The technology enables smartphones, tablets, and other devices to perform actions when in close proximity to an iBeacon.

In an embodiment, the phone 1 receives messages from multiple Beacons and stores relevant data fields such as beacon ID, plaza and lane number, latitude/longitude, time and date, and RSSI.

As battery life on mobile devices is a key product differentiator, some devices limit the transmit rate or the effective receive rate for wireless transceivers. For example, iPhones apply such limits to the BLE functionality, resulting in
A maximum transmission rate that is less than the BLE standard maximum
A diminished sample rate when the device is scanning for beacons; that is, the sample rate is less than the BLE transmission standard maximum, so samples cannot keep up with beacons transmitting at that rate.
   These restrictions are relaxed, however, when the iPhone is detecting an iBeacon, so while it is in range of an iBeacon, it is able to record BLE beacon data in background/sleep mode at nearly the same rate as the beacon advertising rate. This requires a system architecture that contains iBeacons to “awaken” iPhones® and beacons to provide advertisements for the toll transaction. The iBeacons must have a coverage zone that extends well upstream from the toll plaza to provide sufficient time for the phones to be ready to record beacon data when travelling through the plaza. A single antenna or multiple low-gain antennas may be used to provide a wide area communications zone to accomplish successful reception of the iBeacon message. These are used in combination with high gain antennas used for the subsequent beacon messages which form a more constrained communication zone. The phone can transmit log data to a server for post processing and analysis, or preferentially analyze it to determine lane number and transmit that information to a server.

The simplest approach, when the phone 1 is acting as a receiver and beacon transmitters are fixed across a roadway, is to transmit BLE undirected non-connectable advertisements. The format of the advertisement message is defined in the BLE standard, and includes 31 bytes of user-defined data that can include all relevant information for a toll transaction. The phones operate as BLE passive scanners and do not transmit. An individual phone would likely hear multiple beacons as it traverses a toll plaza, and would have to process the data to determine lane location or transfer the data to a back office for post-processing, including lane location.

Non-connectable, undirected BLE advertisements have a minimum time interval between advertisements of 100 msec. This time represents 14.7 feet for a vehicle traveling at 100 mph. Shorter time intervals are necessary for accurate signal strength histories, and are also useful for timing coordination with existing sub-systems in a toll plaza such as video camera systems. Connectable, directed BLE advertisements have a minimum time interval between advertisements of 20 msec, or 2.9 feet for a vehicle traveling at 100 mph. This provides much improved resolution while eliciting BLE scan requests from mobiles.

Further time resolution may be achieved by including multiple BLE modules in a beacon. For instance, two beacons can share an RF connection to an antenna, making the effective advertisement interval equal to 10 msec. The mobile application 17 would have to correctly interpret advertisements from both beacons as coming from the same lane, a simple matter of software. Finally, a high duty cycle mode exists in BLE connectable directed advertisements, where the maximum advertising interval is 3.75 msec. This would provide a significant increase in resolution, perhaps more than necessary for a toll system. However, not all devices support this high duty cycle mode.

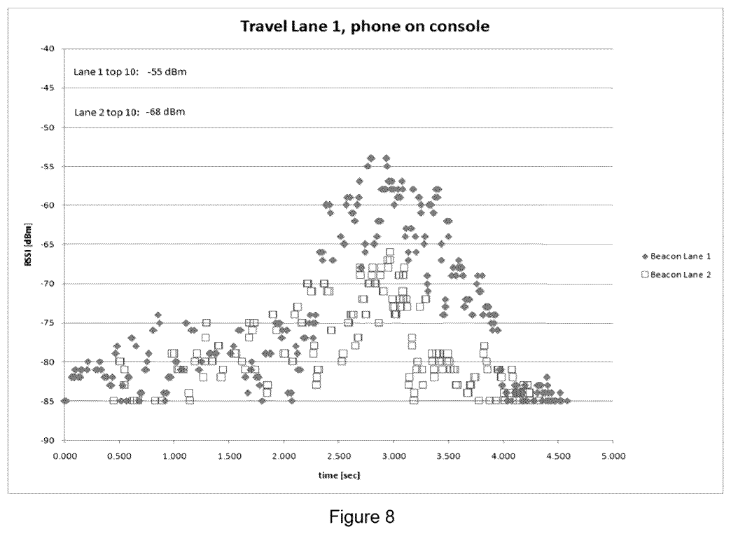

The data recorded on the phone 1 would likely include, at a minimum, timestamp, beacon ID, and RSSI for each sample. The sample plot in FIG. 8 displays BLE RSSI recorded on a phone located in a vehicle traveling through a lane with a Beacon overhead in the travel lane and another Beacon overhead in an adjacent lane. The difference in peak signal strength between two Beacons is clear, and one Beacon is clearly stronger for the majority of the record.

This concept is not restricted to BLE, as the wireless protocol could be WiFi or any other that is available on a smartphone.

### Signal Strength of Beacon Signal for Lane Determination

In an approach, multiple messages may be transmitted by a BLE transceiver, or “beacon”, through a high gain antenna and received by the smartphone. The high gain antenna will be generally set up on an overhead gantry with maximum gain direction pointing towards the road surface or slightly up-tilted toward vehicles as they approach the toll point, forming a capture zone on the road where vehicles are in position to communicate with the beacons. While the capture zones for each beacon will overlap in a typical case of one antenna per standard-width lane, higher signal strengths tend to occur near the antenna boresight. Because the lane numbers are associated with beacons with known IDs, the location of the vehicle can be determined by analyzing RSSI data for the beacons captured on the phone. The phone application 17 may evaluate the number of messages received and the RSSI values from each beacon to determine the position of the phone relative to the beacons, hence the lane. The toll can then be collected from an account associated with the unique ID for the vehicle passing the toll point in that particular lane, wherein the lane/proximate antenna/beacon information is sent with the unique ID to the toll system and or account service center. One approach in this case is that the application on the phone compares the signal strengths received from each beacon antenna to determine the strongest one over a specified period, say 30 milliseconds. As the phone traverses the roadway, each period has a count assigned based on the strongest signal strength received on an antenna, the most proximate antenna or alternatively the lane of travel is determined to be the antenna or lane with the most counts in a larger second period (say 300 milliseconds) or the total such counts during an entire period required to traverse the section of roadway.

Another simple algorithm for lane determination is to examine the strongest N samples for all beacons and average them to create a single number for each lane. This may be thought of as a low-order estimate of the area under the curves, proportional to energy, and possessing increasing accuracy as N increases. As N increases, more calculations are required, which increases the burden on the processor. Hence, a proper value for N is a tradeoff between accuracy and processor burden. In practice, the number N can be arrived at through trial and error. In the case summarized in FIG. 8, the difference in the averages between the correct lane and adjacent lane is 13 dB, using N=10. The difference of 13 dB is also approximately equal to the peaks of the curves. Utilizing a single peak value would provide the correct answer in many cases, but RF multipath can corrupt a single sample more easily than several samples.

To assign the best timestamp for correlating the vehicle passage to other lane sensors, a straightforward algorithm is to use the median of the timestamps for the five data points with highest RSSI in the assigned lane as can be performed for example on the plot in FIG. 8. This synchronized and accurate timestamp, combined with accurate lane position, allows the transaction to be accurately post-processed into the toll system transaction.

To use the system, users download an application 17 with the foregoing capabilities to the smartphone 1. Upon download of the phone application, the user will use application-supported account management features to set up an account with the appropriate toll authority or third party service provider, create a link between the unique ID/address information to the account, and provide a means for the settlement of toll charges associated with the unique ID (such as a credit card).

Zone Definition With Geo-fencing and iBeacons®

The overall goal is to be able to determine which lane a vehicle and phone are in based on messages received from multiple BLE beacons. In an embodiment, upon receiving beacon messages and leaving a Geo-fence area or iBeacon® zone, the raw beacon log data is transferred from smartphone to server for transaction analysis/processing. See FIG. 8 for diagram of beacons within a Geo-fence.

### Smartphone Stores Beacon Time Information and Reports Later

Alternatively, the smartphone application 17 can simply save the Bluetooth® LE beacon messages as the smartphone passes under the high-gain beacons on the toll facility. The messages will contain, at a minimum, data identifying the location of the toll lane and the time the beacon message was sent. The smartphone 1 will normally receive multiple messages from multiple beacons while traversing the toll plaza. A clock in the beacon establishes the time in the message and is synchronized to the other toll equipment to a sufficient resolution (say 1-100 ms) to allow the transaction to be correlated based on the time of the transaction with other elements of the toll system such as a vehicle detection system or a video-based license plate reading system. This saved data is then sent as soon as practical via any of the smartphone's data connections (Bluetooth®, WiFi, WAN data) to a server 20 where the processing to determine the lane position described above is executed. In this case the server 20 need not be located roadside but can be located anywhere.

In one embodiment a Geo-fence function is used to determine when the buffered BLE beacon messages or processed results should be sent to the server over an available data connection. Geo-fence applications are well known in the art and provide a function to allow a specific area to be defined such that an alert is generated when the Geo-zone area is entered or exited. A Geo-zone can be created around the toll plaza or area. When the area is exited an alert triggers the sending of the processed or unprocessed beacon data to the server for post processing into the toll transaction. Similarly, a Geo-zone can be established downstream of the toll point where traffic must traverse, and entry into this Geo-zone can also trigger the sending of buffered data to the server for processing.

It may not be possible given the state of smartphone technology or limitations in smartphone systems to send beacon data in real time to the server. However, because the beacon data contains a timestamp synchronized to the toll system at the toll plaza, a toll transaction can be generated and post-processed with other data collected from other toll sensors proximate to the roadway to form a complete toll transaction. For example, most toll systems include a video-based enforcement/toll system at the toll plaza. Such systems use various techniques well known in the art to take a photo of the vehicle license plate which can later be processed and “read” automatically by a computer. In prior art systems, the toll payment is made by an RFID reader reading an RFID tag associated with a user account that settled to the user's credit card or bank account. If this toll payment is made, the photo taken of the license plate associated with the vehicle does not need to be processed and can be discarded or stored according to policy. If a payment is not made, either a violation against the vehicle owner of record or a video-based toll against an account or the vehicle owner of record is processed.

One advantage of post-processing the transaction data is that substantially all of the data points collected on the transaction between the beacon and the smartphone can be collected and used to determine the lane position and to determine a timestamp for the transaction that best represents when the vehicle passed under the antenna. More data typically means better quality output result for almost any reasonable algorithm used to determine vehicle position relative to the beacon antennas.

Typically a trigger system is used, employing one of many vehicle detection technologies known in the art, to determine the vehicle's location on the roadway to take the photo of the license plate. In order to allow toll payment by smartphone rather than RFID tag, the phone application requires the user to establish an account with the toll authority, or through a private third-party account consolidator who sets up a consolidated account for the user with multiple toll agencies. At that time, an account identifier is established by the application or by an account server in communication with the application over an internet connection supported by the smartphone. That account identifier is sent by the smartphone when the processed or unprocessed beacon data is sent to the server, typically after a Geo-fence or iBeacon zone exit event occurs to trigger the sending of this data. The trigger point for the license plate photograph is aligned to the direction of maximum gain of the antenna, allowing the determined travel lane to be associated with an accurate timestamp. As this timestamp is also synchronized with the video system, the beacon transaction can be compared to the video transaction to ensure they are from the same vehicle, eliminating the need for the license plate photo to be processed.

Typically, this transaction from the smartphone will not occur in real time. This is because the sending of the data will be triggered by an event such as a GeoZone exit (or entry) event, iBeacon read zone exit, or RSSI residing below a threshold for an elapsed time, all of which occur after the vehicle has passed through the toll plaza. Additional sources of latency in the communications network will add to this. All of the data collected as the vehicle traverses the plaza is available for the algorithm that determines the lane and time of passage. It also implies that the photo data and any other associated sensor data pertaining to the toll transaction must be stored for some period of time to allow receipt and processing of the data from the smartphone to create the toll transaction, so that it may be post-processed against this stored data as described above. The minimum period of storage, and the resulting storage capacity, are determined based on the maximum expected delay in sending and processing the smartphone data so that it may be post-processed. Alternatively, all such data may be permanently stored according to policy.

In Apple's® iOS operating system applications that are not actively being used by the user operate in the background. Usually, these applications cannot process data or access resources to preserve battery life. In the contemplated system it is highly advantageous to avoid the need for user action, as a matter of customer convenience and driving safety. There are some exceptions in iOS that will allow some processing time to be allocated to an application running in the background. One exception involves the use of geographical areas. Upon entering a geographical area, the phone application can be automatically launched or elevated in priority by the operating system. Upon receipt of BLE data expected by or intended for the phone application, iOS will provide a specific allotment of time for the application to process the BLE data. In one embodiment, all of the stored BLE messages received are uploaded to the server over the WAN data link using a web services call.

Another approach to resource conservation while the toll application sits in the background is to create iBeacon zones in the roadways that have beacon zones within them. The iPhone will not log iBeacon advertisements at a rate faster than one per second, regardless of the iBeacon advertisement rate. It will record beacon advertisements much faster in general, and approximately at the same rate as the advertisement itself, if the iPhone® is in range of an iBeacon.

### Data Transfer

In a further embodiment, transaction data is stored in a file on the phone. Data can be received and logged even with the phone in sleep mode. Data is downloaded to a server with no user intervention, triggered by an event such as a Geo-fence trigger described above. Because data will not be downloaded in real time, transactions must be post-processed into the toll transaction to be correlated with data taken at the toll area, such as video or camera recording of license plate, and vehicle detection.

### Approach Using Conventional Transponder as Repeater

In one alternative, a transponder device is installed in the conventional electronic toll lane in a similar fashion to how test transponders are used today. The transponder acts as a repeater of the information transmitted by the smartphone. The transponder contains a BLE or WiFi transceiver, which receives transaction information from the phone, including the phone's unique ID. When interrogated by a reader, the transponder will mimic the type of message sent in conventional electronic toll messages with an account ID associated with the phone's unique ID. In this way, the system described above can be implemented with minimal or no changes in the software and integration of the toll system or conventional back office/service center.

### Streamlined Transaction

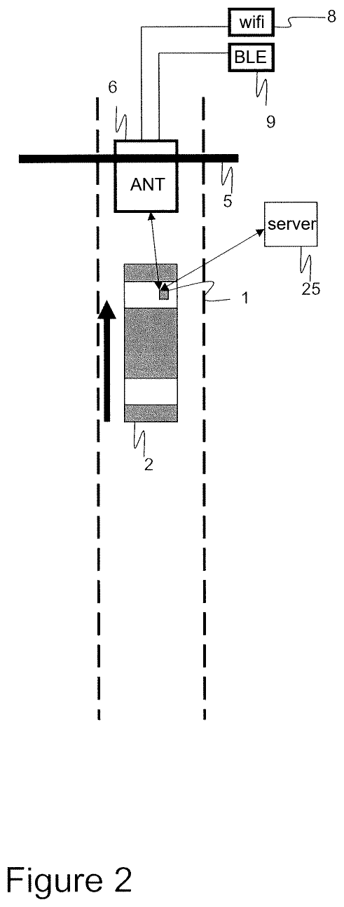

In another embodiment, BLE beacons broadcast advertisements via antennas 6 that are typically dispersed one per lane, although two per lane may be used, or fewer than one per lane may be used. When received in an application 17 resident on the smartphone 1, these advertisements trigger response messages sent by either the BLE radio 13, or WiFi radio 15 in the smartphone 1 with a data response similar to how prior art active RFID transponders behave today. Simultaneously, these BLE Beacon messages could trigger return messages to the toll system over any combination of WIFI (via WiFi radio 15), BLE (via BLE radio 13), or common carrier WAN data connection (via cellular radio 16) present on almost all smartphones 1. These responses contain information that is sent to a service center for the settling of toll collection related to the vehicles' use of the roadway. This information is transmitted to the service center either by a toll system network of the type commonly used today (in the case of WIFI or BLE return message) or via the WAN connection directly from the smartphone 1 to the service center (e.g., remote toll server 25 (FIG. 2)), or any combination thereof which provides for redundancy of messaging and therefore enhanced reliability. In all cases the return message with unique identifier is received at the service center where account settlement is performed, and the toll is settled to the account associated with it. In a further embodiment, a smartphone 1 is a receiver initially scanning passively for BLE advertisements from the beacons as it enters a capture zone. Upon decoding an advertisement, the phone optionally sends a BLE Scan Request (SCAN_REQ PDU) to the beacon. The request payload consists of the beacon address and the phone MAC address. The beacon issues a BLE Scan Response (SCAN_RSP PDU) in response to each received SCAN_REQ. The total number of scan responses represents the number of transactions with a phone.

The timestamp for the transaction resides in the scan request payload and must match the timestamp for other toll systems (i.e. video cameras), within an allowable tolerance.

At the completion of the transaction, the system composes an encrypted data packet containing the phone MAC address, time and date, plaza and lane ID. This is sent to a back office via typical means, for example either over land line communications such as an internet connection or wirelessly such as by a cellular data connection and checked against video data for violations.

### RF Considerations

In an implementation utilizing single-beam antennas, each lane will typically contain an overhead antenna 6 with high gain, circular polarization, and sufficient bandwidth to cover the entire ISM band around 2.45 GHz. The antenna points approximately downward, reducing potential for cross lane communication. By contrast, antenna pointing angles near horizontal can allow large vehicles to block the direct RF path of smaller vehicles in the same lane, and multiple phones in different lanes to be transacted with at relatively longer distances where the beams have spread significantly. Pointing downward, therefore, allows easier control of the capture zone.

A high gain antenna with low side lobes and a sharp beam roll off will minimize RF leakage into the adjacent lanes. This pattern must be consistent across the entire ISM band because BLE uses RF frequencies spanning the band.

Finally, circular polarization is preferred in the Beacon antenna because of the variable antenna pattern in the phone. Linear vertical or horizontal polarization could be used, but circular polarization is preferred so as to make the communication link to the phone less sensitive to the orientation of the phone in the vehicle. This allows the user more flexibility for the phone's location inside the vehicle, including the seat, in pocket, on the vehicle's dashboard, or in its center console, creating good RF link performance unaffected by orientation of the phone. Most antennas targeting 2.45 GHz devices in mobile phones have nulls in each plane. The location and depth of the nulls is dependent on frequency and polarization, and a circularly polarized Beacon antenna will provide polarization diversity.

Frequency diversity is a de-facto feature of the system when using wireless protocols that utilize a sufficiently large RF frequency band. A large operating frequency band causes phone antenna nulls and RF fades to move as frequency changes. In a BLE system, for example, advertising channels hop between 2402, 2426, and 2480 MHz. The antenna operating band must be at least this large to take advantage of this.

The required antenna features of the system described above enhance chances of the in-lane beacon transacting with the phone, as opposed to the adjacent-lane beacon. It does not entirely rule out cross lane transactions, so an appropriate system will monitor the number of transactions on all beacons for a specific phone and choose the travel lane appropriately.

### Multi-Beam Antenna

With smartphones acting as transmitters, the receiving antennas located in the toll plaza may take multiple forms. One embodiment is a pair of multi-beam antennas straddling the roadside to enable angle-of-arrival-based lane determination. A common form for the multi-beam antennas are planar arrays with Butler matrix feed systems.

Butler matrix antenna configurations are known in the art but can be uniquely applied in this case with either the WiFi or the Bluetooth® LE radio signals to track vehicles in which the phones are present and associated. Other forms of directed antenna configurations are also known, see for example U.S. Pat. No. 5,592,181, which is incorporated by reference herein. For example, see the thesis paper: Implementation of a 8×8 Butler Matrix in Microstrip by Henrik Nord incorporated in Appendix A of the provisional Application Ser. No. 62/214,638 filed Sep. 4, 2015 and the slide presentation Design and Implementation of Butler Matrix-Simultaneous Beam Formation, by Harish Rajagopalan, incorporated as Appendix B in the provisional Application Ser. No. 62/214,638 filed Sep. 4, 2015. Both of these documents are incorporated by reference herein. The multi-beam antennas can be used on their own for both communications and tracking, but may also be used with a set of low gain antennas where the low gain antennas cover the entire area of interest to allow more time for reliable communications roadway and the multi-beam antennas used for tracking only or primarily for tracking.

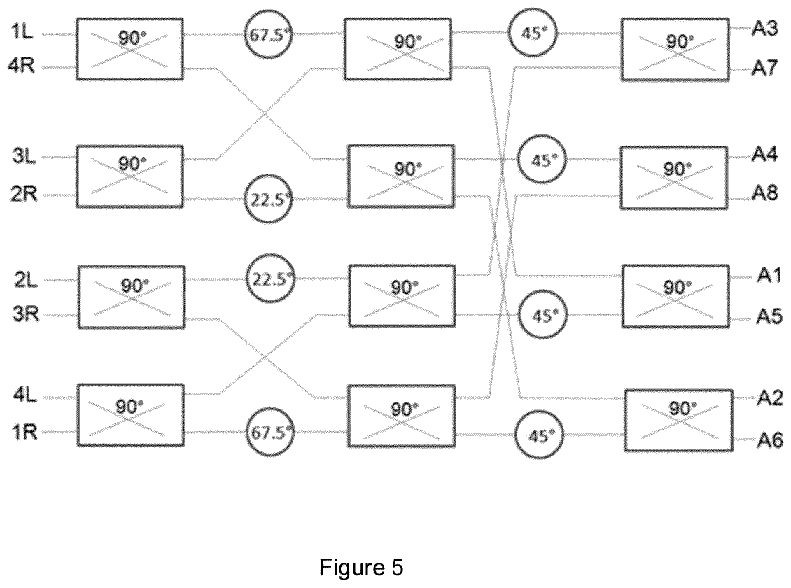

The Butler matrix is a well-known beam-former, producing N beams from N groups of radiators. FIG. 5 is a diagram of an 8×8 Butler matrix. It can be thought of as a hardware realization of a Fourier transform, and indeed the diagram is reminiscent of an FFT.

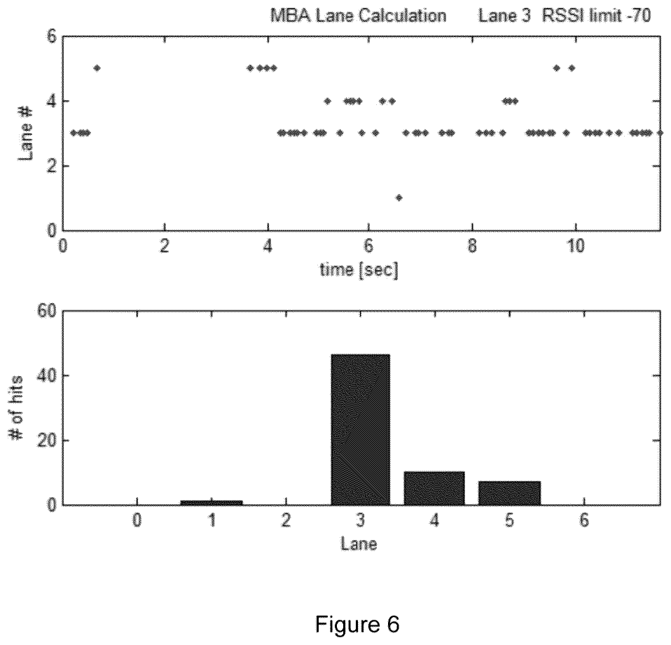

FIG. 6 shows the results of experimental evaluation conducted with two multi-beam antennas installed roadside. The test results showed significant ability to locate the vehicle position across 6 lanes. The graph shows post-processed data: the computed lane number as a function of time, and the total number of hits for each lane. Multipath is evident in hits for lanes beside lane 3 (the actual travel lane). One car at a time was tested.

These experiments were conducted with a 2.45 GHz radio in the vehicle under the dash on the left side of the vehicle, which is a non-ideal position for the transmitter in the vehicle because the signal must reach the receiver via multi-path. Similar, but less severe multi-path can be expected based on the typical locations users will have their phone in the vehicle, be it in the user's pocket, belt, purse, cup holder or passenger seat. All of these locations will potentially see multi-path between the smartphone and exterior antennas, but probably less severe than the conditions of the experiment. Notwithstanding the more severe multi path conditions for the experiment, reasonably good position results were obtained in determining the lane of travel by assigning the transmitter to a lane position by summing the number of points where the peak beam signal strength of the Butler matrix antennas indicated an intersection point in a particular lane and assigning the lane position to the lane with the greatest number of such points as the vehicle traverses a section of roadway.

To use the system, users download an application 17 to the smartphone 1. Upon download of the phone application, the user will use application supported account management features to set up an account with the appropriate toll authority or third party service provider, create a link between the unique ID/address information to the account, provide a means for the settlement of toll charges associated with the unique ID (such as a credit card).

The test results (FIG. 6) showed significant ability to locate the vehicle position across 6 lanes. The graph shows post-processed data: the computed lane number as a function of time, and the total number of hits for each lane. Multipath is evident in hits for lanes beside lane 3 (the actual travel lane). One car at a time was tested.

### Mileage Reporting System for Mileage Based User Fees

In another embodiment, the smartphone application is configured to support the accurate and secure self-reporting of miles driven by taxpayers in jurisdictions where taxes are collected based on the number of miles driven in the jurisdiction. As a possible way to meet policy objectives, California and Oregon have pilot projects and consideration is being given to similar taxation system by the U.S. Federal Government. However, a practical, private, easy, accurate and secure way for users to report the mileage and corresponding tax has been lacking.

The basic reporting approach of the invention involves installing BLE beacons at locations convenient to the motorists, such as gas stations, oil change facilities, smog check stations, and car washes, called reporting facilities. In an exemplary embodiment, drivers self-report the mileage and pay the tax periodically, perhaps once per quarter or per year. The phone application of the invention makes it easy and secure to report mileage.

The design of the phone application is such that the user enters a reporting facility and parks in a designated location designed to be covered by the BLE beacon. The beacon data includes location data and a secure identifier. In one embodiment the secure identifier is an encrypted combination of the time and location information. The locations are selected and high gain antennas placed such that no more than one vehicle can be parked in a designated location simultaneously.

The phone application recognizes the beacon, processes the data, and starts the procedure. The user is prompted to take a photo of the vehicle odometer reading, and the application records the fact that the photo was taken proximate to the secure beacon and a specific date and time. Next the user is prompted to take a picture of the VIN or license plate number, and the application records that the VIN is also proximate to the same secure beacon at the same date/time (within a tolerance). This ensures that in fact the odometer photo and the VIN or license plate number photo are from the same vehicle.

The phone application applies OCR techniques to the odometer reading to create a data element and compares this reading to the previous reading. The application calculates the tax based on the difference in mileage from the previous reading.

Once the tax owed is calculated the phone application then prompts the user to make payment by electronic check, ACH, or credit card, Pay Pal® or other known payment systems. These payment methods can be newly established at the time of payment or stored at the user's preference. The user makes payment and an official receipt is sent to the users stored e-mail address.

If a user wishes to account for miles driven on non-taxable roads that might be exempt from the tax, such as out of state or private roads, a BLE beacon can similarly be placed at the access point to those facilities. For example, BLE beacons can be installed at the state borders to account for out of state miles. The phone application detects these border beacons to validate that the vehicle has indeed crossed the state line. Alternatively, two beacons in sequence could be used to validate the direction of travel at the state line. The secure border beacon location data is stored in the application. The phone application then sets up a large position change feature on the phone, so that the phone application is activated by the phone upon a significant change in position, or after a certain period of time has elapsed. Upon activation, the application evaluates the data from at least one GPS fix to determine the estimated miles driven from the border beacon location. Upon each subsequent activation of the application on the phone a new GPS fix is taken and an incremental number of miles driven out of state. This process continues until the phone crosses another border beacon system indicating re-entry into the state (or alternatively, a GPS position fix within the state). The total accumulated miles out of driven out of state can be determined.

In addition, if policy dictates the need to collect mileage based tax or fee at different rates on different types of roadways this can be accommodated by the system design. For example, if a different rate is to be charged for controlled access highways than arterials, beacons can be placed on the controlled access points to identify entry and exit points which allow the determination of total miles driven on controlled access highways. Those miles can be accumulated in a separate buffer such that at the time of tax payment calculation the tax due can be determined based upon the differentiated miles driven. Similarly, when miles are driven on a toll facility which might typically be exempt from a mileage charge, BLE beacons on the toll facility can be segregated to calculate the correct adjustment to the tax owed at time of payment.

Of course, as described in this disclosure the BLE beacons can work with the phone application to be the primary method of toll collection. providing a seamless approach for the user to pay for services rendered.

What is claimed is:

1. A method for determining a vehicle position, comprising:
receiving a signal associated with a vehicle tracking system, the received signal including a timestamp associated with the vehicle tracking system and an identifier associated with a lane of a roadway;
determining a signal characteristic for the received signal;
determining, based on the identifier and the signal characteristic of the received signal, a position of a vehicle; and
transmitting a signal including the timestamp and the determined position of the vehicle.

2. The method of claim 1, wherein the determining of the position of the vehicle comprises determining a lane of travel of the vehicle.

3. The method of claim 1, wherein determining the position of the vehicle is further based on the timestamp.

4. The method of claim 1, wherein the timestamp is based on a local clock of the vehicle tracking system.

5. The method of claim 1, wherein the signal characteristic is a signal strength of the received signal.

6. The method of claim 1, wherein the received signal comprises a Bluetooth signal or a WiFi signal transmitted from the vehicle tracking system.

7. The method of claim 1, comprising:
receiving a plurality of signals associated with the vehicle tracking system, each of the plurality of received signals including a respective timestamp associated with the vehicle tracking system and a respective identifier associated with respective lanes of the roadway; and
determining signal characteristics for each of the plurality of received signals,
wherein determining the position of the vehicle comprises analyzing the determined signal characteristics with respect to the respective identifiers to determine a selected identifier selected from the respective identifiers, the position of the vehicle corresponding to the lane of the roadway associated with the selected identifier.

8. The method of claim 7, wherein analyzing the determined signal characteristics comprises: determining signal analysis information for the respective lanes of the roadway by compiling the signal characteristics for each of the respective identifiers to determine a compiled characteristic value for each of the respective identifiers, wherein the selected identifier is determined based on the compiled characteristic values.

9. The method of claim 7, wherein the selected identifier is determined further based on the respective timestamps.

10. The method of claim 7, wherein analyzing the determined signal characteristics comprises:
determining, for each of the respective identifiers, an area under a curve for the plurality of received signals; and
determining the lane of the roadway corresponding to the position of the vehicle based on the respective identifier being associated with a greatest area under the curve.

11. The method of claim 7, wherein analyzing the determined signal characteristics comprises:
determining, for each of the respective identifiers, a count of signals of the plurality of received signals in which the respective determined signal characteristics satisfy a threshold; and
determining one of the respective identifiers having a greatest count as the lane of the roadway corresponding to the position of the vehicle.

12. The method of claim 7, wherein analyzing the determined signal characteristics comprises:
determining, for a plurality of periods and for each of the respective identifiers, a count of signals of the plurality of received signals in which the respective determined signal characteristics satisfy a threshold;
determining, for each of the respective identifiers and for a second period, a sum of the respective counts of signals of the plurality of received signals in which the respective determined signal characteristics satisfy a threshold; and
determining one of the respective identifiers having a greatest of the sums as the lane of the roadway corresponding to the position of the vehicle.

13. The method of claim 1, further comprising:
receiving, by a communication device associated with the vehicle, a beacon signal associated with the vehicle tracking system; and
causing, based on the beacon signal, the communication device to:
determine the signal characteristic for the received signal;
determine the position of a vehicle; and/or
transmit the signal including the timestamp and the determined position of the vehicle.

14. A non-transitory computer-readable medium comprising instructions, which when executed by a processor of a mobile device, cause the processor to form the method of claim 1.

15. An electronic device comprising one or more processors; and memory storing instructions that, when executed by the one or more processors, configure the electronic device to perform the method of claim 1.

16. A method for determining a vehicle position, comprising:
transmitting, by a vehicle tracking system, a plurality of first signals, each of the plurality of first signals including a respective first timestamp associated with the vehicle tracking system and a respective identifier associated with a lane of a roadway;
receiving a second signal associated with a vehicle, the second signal including a second timestamp associated with one of the respective first timestamps; and
determining, based on the received second signal, a position of the vehicle.

17. The method of claim 16, wherein the determining the position of the vehicle comprises determining a lane of travel of the vehicle.

18. The method of claim 16, wherein the second signal further comprises a lane identifier associated with one or more of the respective identifiers of the plurality of first signals, and determining the position of the vehicle comprises determining a lane of travel of the vehicle based on the received lane identifier.

19. The method of claim 16, wherein the second signal comprises signal characteristic information associated with one or more signal characteristics of one or more of the plurality of first signals, the position of the vehicle being determined based on the signal characteristic information.

20. The method of claim 19, wherein the one or more signal characteristics are one or more respective signal strengths of the one or more of the plurality of first signals.

21. The method of claim 16, further comprising associating information of the second signal with additional information obtained by the vehicle tracking system by associating the second timestamp with a third timestamp associated with the additional information, the third timestamp and the second timestamp being the same.

22. The method of claim 21, wherein the position of the vehicle is determined further based on the additional information associated with the information of the second signal.

23. The method of claim 21, wherein the additional information is based on sensor data obtained by one or more sensors of the vehicle tracking system.

24. The method of claim 16, further comprising facilitating a toll transaction based on the determined position of the vehicle.

25. The method of claim 24, wherein the toll transaction is facilitated by associating information of the second signal with additional information obtained by the vehicle tracking system by associating the second timestamp with a third timestamp associated with the additional information, the third timestamp and the second timestamp being the same.

26. The method of claim 16, wherein the second timestamp comprises one of the respective first timestamps.

27. The method of claim 16, wherein the second timestamp is based on a clock associated with the vehicle tracking system.

28. The method of claim 16, wherein the one or more of the plurality of first signals comprises a Bluetooth signal or a WiFi signal transmitted from the vehicle tracking system.

29. The method of claim 16, wherein the second signal comprises a Bluetooth signal or a WiFi signal transmitted from the vehicle or an electronic device associated with the vehicle.

30. A non-transitory computer-readable medium comprising instructions, which when executed by a processor of a mobile device, cause the processor to form the method of claim 16.

31. An electronic device comprising one or more processors; and memory storing instructions that, when executed by the one or more processors, configure the electronic device to perform the method of claim 16.

32. A method comprising:
receiving, by a computing device associated with a vehicle and from a tolling facility, a first message, wherein the first message comprises:
first information that indicates the tolling facility;
second information that identifies a lane of a plurality of lanes of travel associated with the tolling facility; and
a first timestamp;
determining, by the computing device and based on the first message, a first proximity of the vehicle to the tolling facility;
transmitting, by the computing device and to the tolling facility, based on receiving the first message, and based on a second proximity of the vehicle to the tolling facility, a second message that comprises:
third information that indicates an entity responsible for processing a toll associated with the vehicle traversing the tolling facility;
fourth information that indicates a position of the vehicle with respect to the plurality of lanes of travel as the vehicle traverses the tolling facility;
a unique identifier (ID) associated with the vehicle or a driver of the vehicle; and
a second timestamp; and
providing payment information to the tolling facility to facilitate payment of a toll associated with the position of the vehicle as the vehicle traverses the tolling facility.

33. The method of claim 32, wherein the first message comprises an advertisement message.

34. The method of claim 32, wherein the computing device comprises a smartphone.

35. The method of claim 32, wherein receiving comprises receiving the first message from roadside equipment of the tolling facility.

36. The method of claim 32, wherein transmitting comprises transmitting the second message to roadside equipment of the tolling facility.

37. The method of claim 32, wherein the payment of the toll is based on a lane of travel of the vehicle.

38. The method of claim 32, wherein receiving comprises receiving the first message over a low power communication link.

39. The method of claim 32, wherein transmitting comprises transmitting the second message over a low power communication link.

40. The method of claim 32, wherein transmitting comprises transmitting the second message over a cellular communication link.

41. The method of claim 32, wherein the first timestamp and the second timestamp are the same.

42. The method of claim 32, wherein the first message further comprises fifth information that indicates a tolling authority, and wherein the tolling authority and the entity are the same.

43. The method of claim 32, further comprising receiving a plurality of first messages, wherein the plurality of first messages collectively identify the plurality of lanes of travel associated with the tolling facility.

44. The method of claim 32, wherein the first proximity comprises a position of the vehicle before traversing the tolling facility, and the second proximity comprises a position of the vehicle after exiting the tolling facility.
